(19) United States
(12) Patent Application Publication
(10) Pub. No.: US 2012/0138521 A1
(43) Pub. Date: Jun. 7, 2012

(54) Plastic Filters of Irrigation Systems

(76) Inventor: Yasin Coskun, Konya (TR)

(21) Appl. No.: 13/125,974

(22) PCT Filed: Jun. 9, 2010
(86) PCT No.: PCT/TR2010/000109

§ 371 Date: Apr. 26, 2011

(30) Foreign Application Priority Data
Jul. 27, 2009 (TR) 2009/05809

(51) Int. Cl. B01D 35/02; C02F 1/00

(52) U.S. Cl. 210/232

(57) ABSTRACT

Invention is about improvements that are made in water redirecting, disk cleaning systems and sealing of filters which are used in irrigation systems for filtering contaminants at solid state in the water. Water leakage is prevented by separate usage of seal and o-ring as sealing between body and container. Another problem is solved by design of fixed stream director apparatus. To prevent disc moving from their axis during screw releasing of upper cap, a cap was designed and easy disc cleaning attained by same dimension of inner diameters of movable cap and disc holder.

### TECHNICAL AREA

Invention is about improvements that are made in water redirecting, disk cleaning systems and sealing of filters which are used in irrigation systems for filtering contaminants at solid state in the water.

### PRIOR ART

Water leads the most important needs which are necessary for life. Using limited water sources with the most efficient way has been becoming more and more important. Forasmuch as insufficient irrigation is performed, it is hard to obtain efficiency at many areas of agriculture. Water should be delivered without any loss to the target, in order to achieve optimum efficiency. This fact improves value of sealing elements. One sealing is used between filter body and vessel, which in the end resulted with water leakage. Desired pressure can't be reached at irrigation systems because of insufficient sealing of one seal against pressure, so expected irrigation couldn't be fulfilled and desired efficiency couldn't be attained. Also water, work power and energy losses are added to account of country.

Another problem that is faced is cleaning disks during operation to make contaminants (foreign matters) fall (sediment, settle) downwards in order to observe filters main work which is cleaning solid contaminants. This duty is performed by stream director apparatus. Stream director apparatus in filters that are manufactured by known practice, starts to rotate by the pressure that water drives and can't perform its spiral directing job, because that it is not fixed. Direct water transition through filter causes rapid filling of discs and in consequence, it makes them work insufficiently. This situation requires operator action. If operator doesn't act, pressure would decrease and transferred water amount would degrade. This means insufficient irrigation. Filter cleaning is done as operator opens upper cap after releases its screw and moves discs towards upwards and downwards. In the known technique, discs make operator job harder by moving from their axis due to thin screw belly (body) of upper cap, comparing to disc holder inner diameter. It becomes harder when above disadvantage added to hard cleaning conditions and this prevents proper and sufficient execution of procedure. Also time and work power losses must not be forgot.

### BRIEF DESCRIPTION OF INVENTION

In the filter that is developed at the end of studies of our experts by initiating with disadvantages of known technique, water leakage is prevented by separate usage of seal and o-ring as sealing between body and container. Another problem is solved by design of fixed stream director apparatus. To prevent disc moving from their axis during screw releasing of upper cap, a cap was designed and easy disc cleaning attained by same dimension of inner diameters of movable cap and disc holder.

### MEANING OF FIGURES

FIG. 1. Assembled view

FIG. 2. Disassembled view

FIG. 3. Spiral mixer (twister)

FIG. 4. Cap

FIG. 5. Container

FIG. 6. Disc holder

FIG. 7. Body

FIG. 8. Screw

FIG. 9. Nut

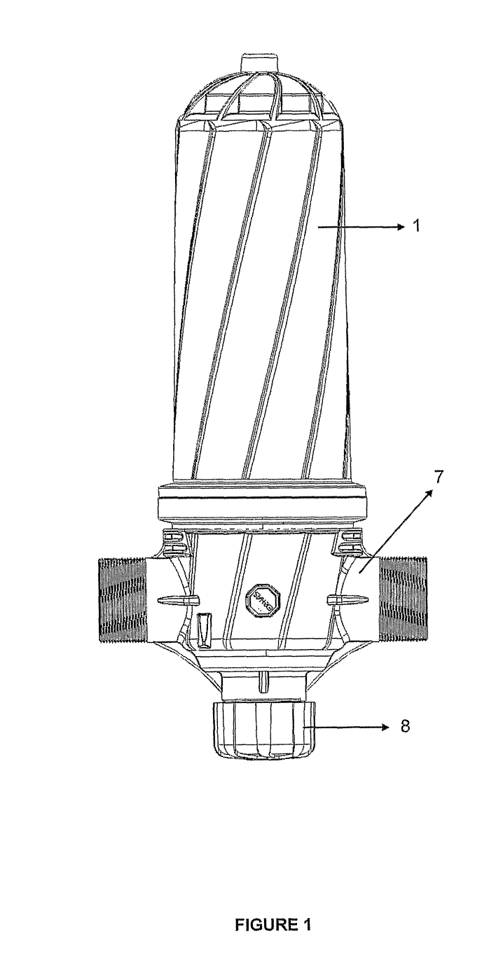

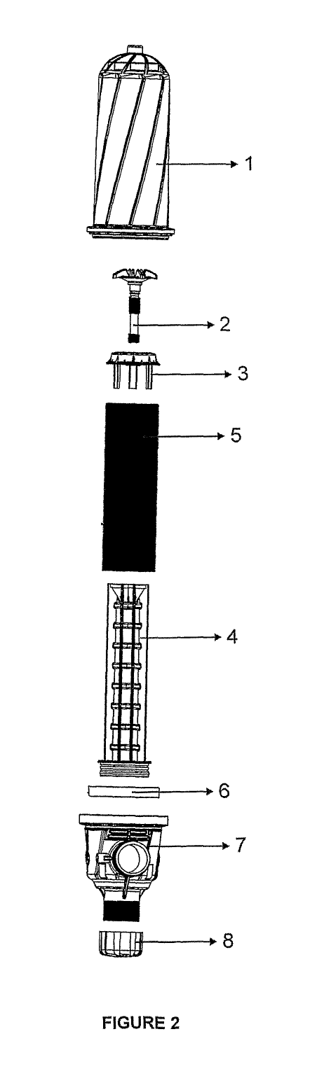

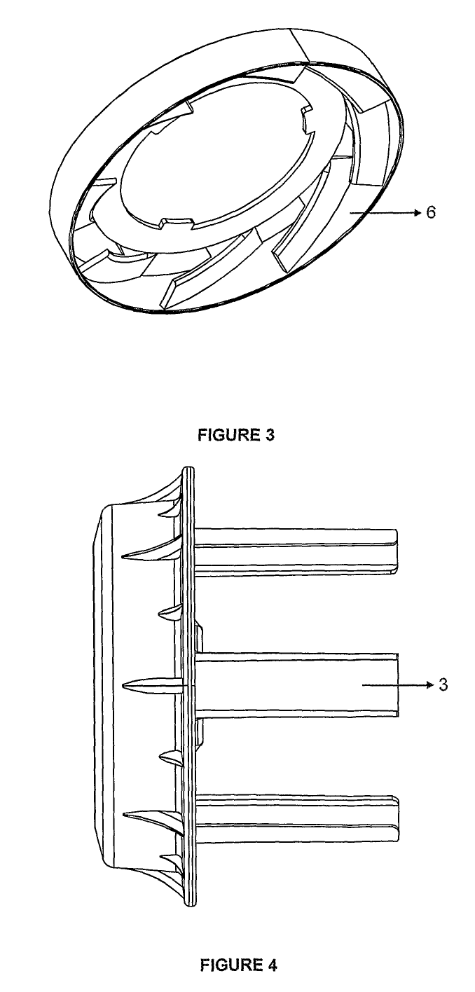

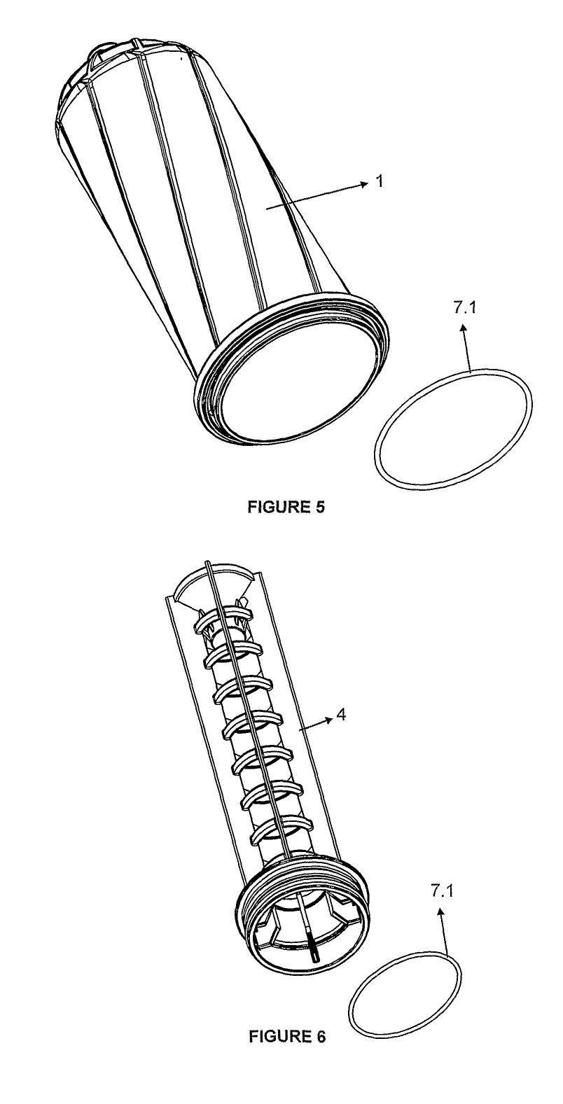

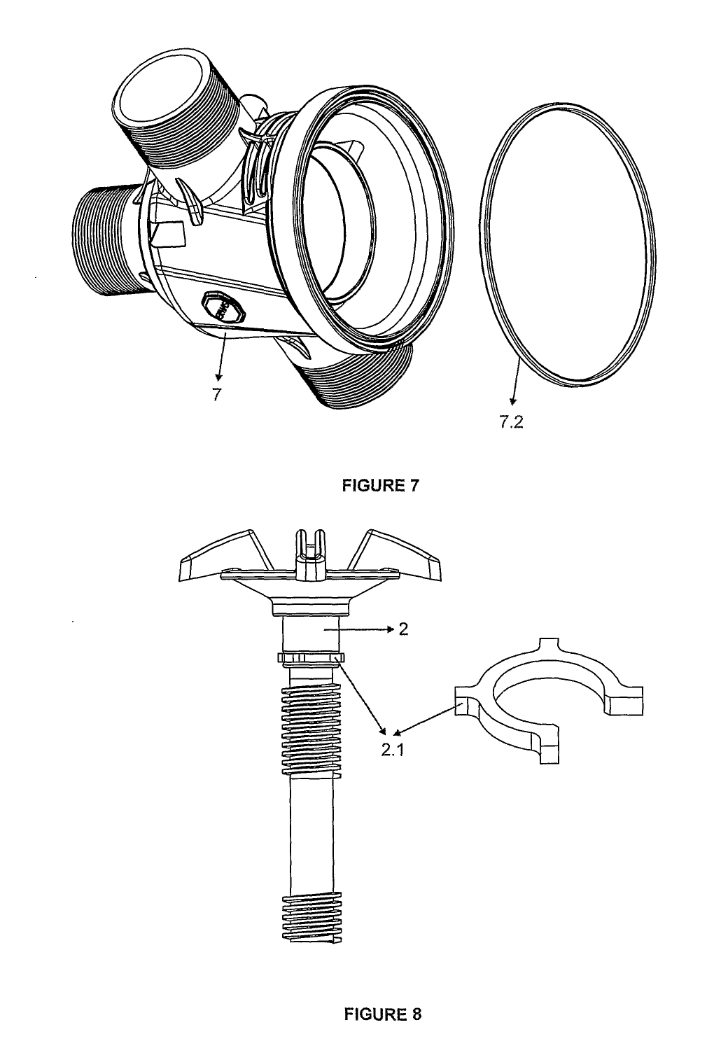

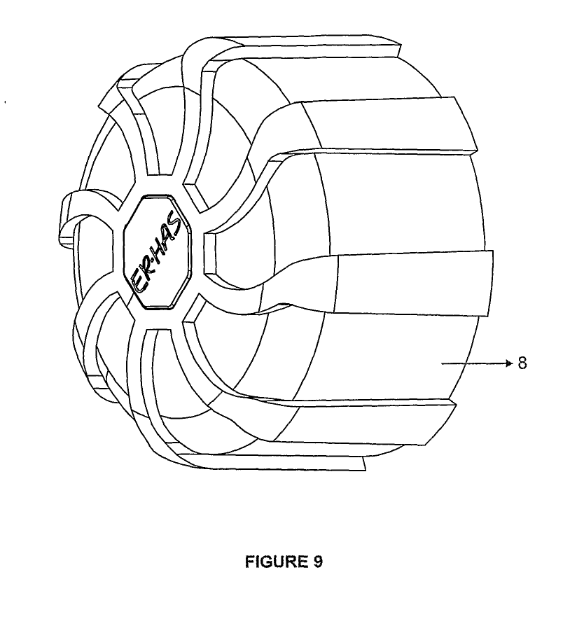

Meanings of part numbers which are provided at figures are given below.

1. Container

2. Screw
2.1. Segment

3. Cap

4. Disc holder

5. Disc

6. Twister

7. Body
7.1. O-ring
7.2. Seal

8. Nut

### DETAILED DESCRIPTION OF INVENTION

Invention is consist of Container (1), Screw (2) which contains Segment (2.1), Cap (3), Disc holder (4), Disc (5), Twister (6), Nut (8) and Body (7) which contains O-ring (7.1) and Seal (7.2). Starting filter assembly is initiated with nut (8) mounting after mounting seal (7.2) and o-ring (7.1) to sealing channels of the body. After that, twister (6) mounted to disc holder (4) and discs (6) which have filtering contaminant solid substances during their filter transition, are aligned (lined up) on disc holder (4). Cap (3) mounted and screwed (2) after disk (5) aligning job completed. Filter becomes ready when container (1) and body (7) are fitted. A phased sealing system is placed between container (1) and body (7), channels that o-ring (7.1) and seal (7.2) can be used together is made and seal (7.2) and o-ring (7.1) are placed to these channels separately so probable water leakages are avoided. After water enters filter, it faces twister (6) which is mounted to disc holder (4) that is placed just over the water entry. Twister (6) sends water to discs (5) as spiral stream. While discs (5) hold foreign substances, water makes those substances to fall downwards by its spiral movement. At filter cleaning, cap (3) that mounted onto disc holder (4), slides to upwards by released screw (2) and discs (5) move easily without horizontal movement. Operator cleans easily and rapidly and make filter ready to re-operate.

What is claimed is:

1. A plastic filter for an irrigation system comprising: a plastic container with a space to place a rubber O-ring in the plastic container; a plastic screw with plastic segment thereof; a plastic cap; a plastic disc holder; a plastic twister attached to the plastic disc holder; a rubber seal; and a plastic body wherein the rubber seal is attached to.

2. The plastic filter as described in claim 1 wherein said plastic cap has three standing supports.

3. The plastic filter as described in claim 1 wherein the plastic twister has plurality of grooves in it.

4. The plastic filter as described in claim 3 wherein the plastic twister has three grooves in it.

5. The plastic filter as described in claim 3 wherein the plastic twister is attached to the plastic disc holder via one of the three grooves of the plastic twister to prevent rotating of plastic twister to the left and to the right during water flow and to gain helical flow of water.

6. The plastic filter as described in claim 1 wherein the plastic cap extends to the length of the plastic disc holder by loosening of the plastic screw and exists on the plastic disc holder with the same size of the plastic disc holder.

7. The plastic filter as described in claim 1 wherein the plastic screw comprises a plastic segment thereof to prevent a plastic disc from falling between the plastic screw and the plastic disc holder during cleaning of solid particles on the plastic disc.

8. The plastic filter as described in claim 1 wherein the rubber o-ring is placed on the plastic container.

9. The plastic container as described in claim 8 further comprising a space to place O-ring to provide sealing between the plastic body and the plastic container.
